(19) United States
(12) Patent Application Publication
(10) Pub. No.: US 2019/0031248 A1
(43) Pub. Date: Jan. 31, 2019

(54) MOUNTING CLIP AND FACEPLATE ARRANGEMENT FOR A MOTOR VEHICLE

(71) Applicant: GM GLOBAL TECHNOLOGY OPERATIONS LLC, Detroit, MI (US)

(72) Inventors: Andreas Rogge, Gimbsheim (DE); Alexej Mielke, Ruesselsheim (DE)

(73) Assignee: GM GLOBAL TECHNOLOGY OPERATIONS LLC, Detroit, MI (US)

(21) Appl. No.: 16/043,863

(22) Filed: Jul. 24, 2018

(30) Foreign Application Priority Data
Jul. 27, 2017 (DE) 102017007164.0

(51) Int. Cl. B62D 27/02

(52) U.S. Cl. CPC B62D 27/02

(57) ABSTRACT

A mounting clip is disclosed for mounting a faceplate on a motor vehicle body. The mounting clip includes a clip body having an abutment shoulder, a catch element and a locking element. The clip body can preferably abut on a carrier with the abutment shoulder. The catch element extends away from the abutment shoulder of the clip body along a first direction and is further arranged on the clip body such that the catch element is flexible or pivotable along a second direction, which is different than the first direction.

### CROSS-REFERENCE TO RELATED APPLICATION

This application claims priority to German Patent Application No. 102017007164.0, filed Jul. 27, 2017, which is incorporated herein by reference in its entirety.

### TECHNICAL FIELD

The present disclosure pertains to a faceplate arrangement for a motor vehicle, as well as a mounting clip provided therefor. The development furthermore pertains to a motor vehicle body equipped with such a faceplate arrangement, as well as a corresponding motor vehicle.

### BACKGROUND

The mounting of faceplates or decorative elements on the skin of a motor vehicle body has to fulfill various requirements with respect to installation accuracy, manufacturing tolerances, longevity and durability, as well as requirements with respect to the simplest and most cost-efficient installation possible. Separate carriers of plastic are frequently provided for mounting decorative elements or faceplates on the exterior of a motor vehicle. Mounting clips that are realized, for example, in an elastically movable fashion are provided on the plastic carrier.

In other mounting concepts, for example, the faceplate is provided with catch elements that protrude inward, e.g., from a lateral edge of the faceplate. However, conventional mounting concepts reach their limits if the lateral edge of the faceplate should be externally visible due to styling or design specifications. This applies all the more in light of the fact that a carrier for the faceplate is subject to additional styling or design specifications, particularly with respect to its surface finish. High-gloss plastics suitable for exterior use are comparatively inflexible and brittle such that the integration of flexible catch projections or similar mounting elements thereon is precluded.

The present enhancement, in contrast, is based on the objective of making available a mounting configuration for securing a faceplate on a motor vehicle body. This mounting configuration should make it possible to intuitively and persistently mount the faceplate in its exact position on the motor vehicle body as easily as possible and, if applicable, in a detachable fashion.

### SUMMARY

Accordingly, a mounting clip for mounting a faceplate on a motor vehicle body is described. The mounting clip includes a clip body, at least a first catch element and a locking element. The clip body includes an abutment shoulder. The clip body can preferably abut on a carrier with the abutment shoulder. The first catch element extends away from the abutment shoulder of the clip body along a first direction. It is furthermore arranged on the clip body such that it is flexible or pivotable along a second direction, which is different than the first direction. In other words, the first direction and the second direction do not coincide.

The first direction particularly extends at a predefined angle to the second direction. For example, the first and the second direction may include an angle of 90°. The locking element is arranged on the clip body such that it can be moved between a release position and a locking position. In the locking position, the locking element blocks a motion of the first catch element along the second direction. Since the locking element is movably arranged on the clip body, the mounting clip can be configured between a locking position and a release position.

In the locking position, the locking element blocks a motion of the first catch element along the second direction such that the mobility of the catch element can be purposefully restricted due to its blockade, for example, in order to prevent an uncontrollable detachment of the catch element from a mounting profile of a faceplate. The mounting clip may in the release position be engaged with a mounting profile of a carrier with its first catch element and with the locking element.

When a mutual and typically positive engagement between the mounting profile and the catch element is produced, e.g. due to a flexible or pivoting motion of the catch element along the second direction, a flexible motion of the first catch element or a pivoting motion of the first catch element along the second direction can be blocked by moving the locking element from the release position into the locking position. Due to the locking element and its ability to block the motion of the first catch element along the second direction, the first catch element can remain positively engaged with the mounting profile of a faceplate and thereby be secured from detaching.

When the locking element is in the release position, the catch element is flexible or pivotable relative to the clip body or relative to the abutment shoulder along the second direction. This allows a particularly simple installation because any elastic restoring forces of the catch element can be comparatively low. Once the first catch element is engaged with the corresponding mounting profile of the faceplate, any motion of the catch element relative to the clip body, which could lead to a separation of the positive connection, can be prevented by transferring the locking element from the release position into the locking position.

According to another embodiment, the locking element allows a motion of the first catch element along the second direction in its release position. The catch element or its positive engagement with a mounting profile of the faceplate can be effectively locked or unlocked by moving the locking element between the locking position and the release position. This furthermore allows a detachable installation of the faceplate, for example, on a carrier of a faceplate arrangement.

According to another embodiment, the mounting clip furthermore includes a second catch element that extends away from the abutment shoulder along the first direction. The second catch element is arranged at a predefined spacing from the first catch element. It is likewise arranged on the clip body such that it is flexible or pivotable along the second direction. The second catch element or its longitudinal extent has at least one directional component along the first direction. In other words, it may also extend away from the abutment shoulder of the clip body obliquely to the first direction at a predefined angle greater than 0°.

The first and the second catch element may also be respectively arranged parallel to one another or oriented parallel to one another. The first catch element may be arranged on the clip body such that it can be elastically deformed or pivoted along the second direction against a restoring force and the second catch element may be arranged on the clip body such that it is elastic or pivotable against a restoring force along the second direction, however, opposite to the first catch element.

The first and the second catch element may be elastically or pivotably moved toward one another such that their spacing from one another is reduced, for example, in order to be engaged with a mounting profile of a faceplate, and that the first and the second catch element once again reassume their original position under the influence of an elastic restoring force after they are engaged with the mounting profile.

According to another embodiment, the locking element is in its locking position located in an intermediate space between the first catch element and the second catch element. In its release position, however, the locking element is predominantly located outside the intermediate space. If the first and the second catch element are pivotably or flexibly arranged on the clip body, particularly the free end sections of the first and the second catch element, which face away from the clip body, may be subject to a comparatively large motion along the second direction or opposite to the second direction, respectively.

In its locking position, at least part of the locking element is typically located in the intermediate space between the free end sections of the first and the second catch element. In this way, a motion of the first and the second catch element along the second direction taking place at this location can be prevented in a particularly simple and effective fashion. In order to allow a motion of the first and/or second catch element along the second direction, it may suffice to pull out the locking element from the intermediate space between the locking elements in the longitudinal direction of the first and/or second catch element.

The locking element may preferably be transferred into the release position in the direction toward a base region of the first and/or second catch element. In the release position, at least a section of the locking element may still be located in the intermediate space between the first and the second catch element. If the first and the second catch element are realized elastically or flexibly, for example, the free end sections of the first and the second catch element designed for engaging with the mounting profile can carry out the motion required for producing the engagement.

According to another embodiment, the locking element has an outside diameter that essentially corresponds to an inside spacing between the first catch element and the second catch element. In this way, the locking element can almost completely fill an intermediate space between the first catch element and the second catch element upon reaching its locking position.

In this way, the catch elements cannot be moved toward one another. They are effectively blocked with respect to the second moving direction. If the first and the second catch element are realized symmetrically to one another or arranged on the clip body symmetrically referred to the longitudinal extent of the locking element, any retention forces acting upon the catch elements along the second direction can be transmitted into the respectively opposite catch element via the locking element. The catch elements can be mechanically and structurally stabilized by the locking element located in the intermediate space between the catch elements.

According to another embodiment, the locking element extends through a passage opening of the clip body, which is located between the first and the second catch element. The locking element is furthermore mounted on the clip body such that it can be longitudinally displaced in the passage opening of the clip body. In this case, the passage opening of the clip body has a double function. On the one hand, the locking element can be precisely arranged between the first and the second catch element by the passage opening. On the other hand, the passage opening makes it possible to longitudinally displace the locking element on the clip body in a guided fashion. In this way, the locking element can be moved on the clip body between the release position and the locking position while being guided by the passage opening.

The longitudinally displaceable guidance of the locking element on the clip body furthermore makes it possible to captively retain the locking element on the clip body when the locking element is in its release position. In this way, the handling of the mounting clip during the installation of the faceplate arrangement can be simplified. The locking element may particularly be preinstalled on the clip body such that it is unnecessary to separately handle the locking element or manually add the locking element to the clip body during the faceplate installation.

According to another embodiment, at least one of the first and second catch elements includes at least one recess facing the locking element in the region of a base bordering on the abutment shoulder and/or on a free end section facing away from the clip body. The locking element can be positively retained on the clip body in at least its release position or locking position or also in both positions, namely in the release position and in the locking position, with the recess. The locking element may particularly include a widening that corresponds to the recess or a corresponding projection, which in the locking position and/or in the release position engages with the corresponding recess on the base or on the free end section of one or both catch elements. A separation of this positive engagement can be achieved by exerting a displacement force, which lies above a predefined threshold value, upon the locking element.

According to another embodiment, the locking element includes a locking pin with an elongate shaft and with a head that is radially widened relative to the shaft. The locking element is mounted in the passage opening on the clip body in a longitudinally displaceable fashion with its elongate shaft. The radially widened head is typically located on an underside of the clip body that faces away from the abutment shoulder. The radially widened head of the locking pin is therefore located on an underside of the clip body that faces away from the first and/or the second catch element.

Both catch elements typically extend on the upper side of the clip body that faces away from the head of the locking pin. The locking pin may be made of plastic or of metal. The mounting clip may therefore also be realized in the form of a plastic component. The mounting clip and/or the locking pin may be realized, for example, in the form of an injection-molded plastic component. At least the first catch element, but also both catch elements, may be respectively realized integrally with the clip body or integrated into the clip body.

The mounting clip including the clip body, the first catch element and the second catch element may be realized in the form of an integral injection-molded plastic component. The locking element may be realized in the form of a separate plastic or metal component that is displaceable arranged on the clip body.

According to another embodiment of the mounting clip, the shaft of the locking pin includes a shaft widening on its end that faces away from the head. The shaft widening can be positively engaged with the at least one recess in the region of the base and/or in the region of a free end section of at least one of the first and second catch elements. The entire locking element therefore can be positively fixed on the clip body with respect to a displacement along the longitudinal direction of the shaft in the release position, as well as in the locking position by the corresponding recesses and the shaft widening provided on the shaft.

The shaft typically extends parallel to the first direction and therefore parallel to the longitudinal extent of the first and/or the second catch element. In the release position, the shaft widening of the shaft is engaged with a recess on the base of at least one catch element. In the locking position, the shaft widening is engaged with a recess of one of the first and second catch elements in the region of the free end section of the respective catch element.

According to another embodiment, the head of the locking element or locking pin includes an abutment surface facing the shaft. At least one depression that borders on an outer edge of the head, for example an elongate recess or groove, may be formed in the region of the abutment surface. In the locking position, the abutment surface of the head typically abuts on the underside of the clip body. Since a depression that borders on the outer edge of the head and, for example, extends radially is provided in the region of the abutment surface of the head, a tool can be inserted into the depression from outside in order to lever or displace the head from the locking position in the direction of the release position.

The depression bordering on the outer edge of the head therefore makes it possible to respectively detach the mounting clip or to transfer the locking element from the locking position into the release position.

According to another embodiment, the first catch element includes a catch projection, which is provided with a run-up slope and protrudes from an outer side of the catch element facing away from the locking element, on a free end section that faces away from the abutment shoulder. Both catch elements typically include such a catch projection on their respective free end sections that face away from the abutment shoulder. The catch projections are typically provided with a run-up slope that extends toward the free end of the catch elements. A lower end of the catch projections facing the clip body or the abutment shoulder forms an undercut or a recess, with which the catch projections can be positively engaged with a mounting profile of the faceplate.

The catch elements typically have a rectangular cross-sectional contour that also continues into the catch projections. The catch projections may have a consistent cross-sectional profile perpendicular to the first direction and perpendicular to the second direction. An abutment surface of the catch projections abutting on the mounting profile may have a rectangular contour such that a larger abutment surface on the mounting profile can be formed than in instances, for example, in which a catch element or a catch projection is realized with a contour in the form of a circular segment. A larger abutment surface produces a reduced surface pressure on the faceplate upon reaching the final installation position.

According to another embodiment, the first and the second catch element are realized on the clip body symmetrically or arranged on the clip body symmetrically referred to a longitudinal axis of the locking element. A symmetric design or arrangement allows a particularly simple and intuitive engagement with an elongate mounting profile, which is typically arranged or provided on an inner side of a faceplate.

According to another aspect, a faceplate arrangement for being mounted on a motor vehicle body is furthermore proposed. The faceplate arrangement includes a carrier with at least one passage opening. The faceplate arrangement furthermore includes a faceplate that can be connected to the carrier and includes a mounting profile on an inner side facing the carrier. The faceplate arrangement is furthermore provided with a mounting clip of the above-described type, which can be positively engaged with the mounting profile of the faceplate by means of at least its first catch element in such a way that it extends through the passage opening of the carrier.

In this case, the abutment shoulder of the clip body abuts on an inner side of the carrier whereas the at least one catch element, preferably both catch elements, extend through the entire passage opening of the carrier and positively engage with the mounting profile abutting on the outer side of the carrier. As soon as at least the first catch element or as soon as both catch elements are engaged with the mounting profile and have assumed their original position, the locking element can be transferred from the release position into the locking position such that the catch elements remain permanently engaged with the mounting profile.

The faceplate arrangement may be preassembled and supplied to a final assembly process of the motor vehicle body or the motor vehicle in the form of a prefabricated module, i.e. with a faceplate arranged on the carrier by means of one or more mounting clips. Additional clips or similar mounting elements, by means of which the carrier and the faceplate arranged thereon can be captively arranged on the motor vehicle body, may be provided, for example, in the region of the carrier in order to mount the faceplate arrangement on the motor vehicle body.

The faceplate arrangement, particularly its faceplate, is typically realized in the form of a faceplate for a vehicle body pillar, for example an A-pillar, a B-pillar or a C-pillar. The faceplate arrangement may particularly be realized in the form of a faceplate for an A-pillar base in the transition area from the front fender into the A-pillar.

According to another aspect, a motor vehicle body with an above-described faceplate arrangement is furthermore proposed. The development furthermore pertains to a motor vehicle with an above-described mounting clip, with an above-described faceplate arrangement or with an above-described motor vehicle body.

### BRIEF DESCRIPTION OF THE DRAWINGS

The present disclosure will hereinafter be described in conjunction with the following drawing figures, wherein like numerals denote like elements.

FIG. 1 shows a side view of a motor vehicle,

FIG. 2 shows a perspective representation of a faceplate arrangement,

FIG. 3 shows a cross section through a faceplate,

FIG. 4 shows a cross section through the faceplate arrangement according to FIG. 2 in the final installation position,

FIG. 5 shows a perspective and isolated representation of the mounting clip with the locking element in the release position,

FIG. 6 shows a perspective representation of the mounting clip with the locking element in the locking position,

FIG. 7 shows a cross section through the mounting clip according to FIG. 6,

FIG. 8 shows a cross section through the mounting clip during the installation,

FIG. 9 shows another cross-sectional representation of the mountain clip in the final installation position,

FIG. 10 shows a schematic representation of a section of the mounting clip with the locking element in the release position, and

FIG. 11 shows a representation according to FIG. 10 with the locking element in the locking position.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

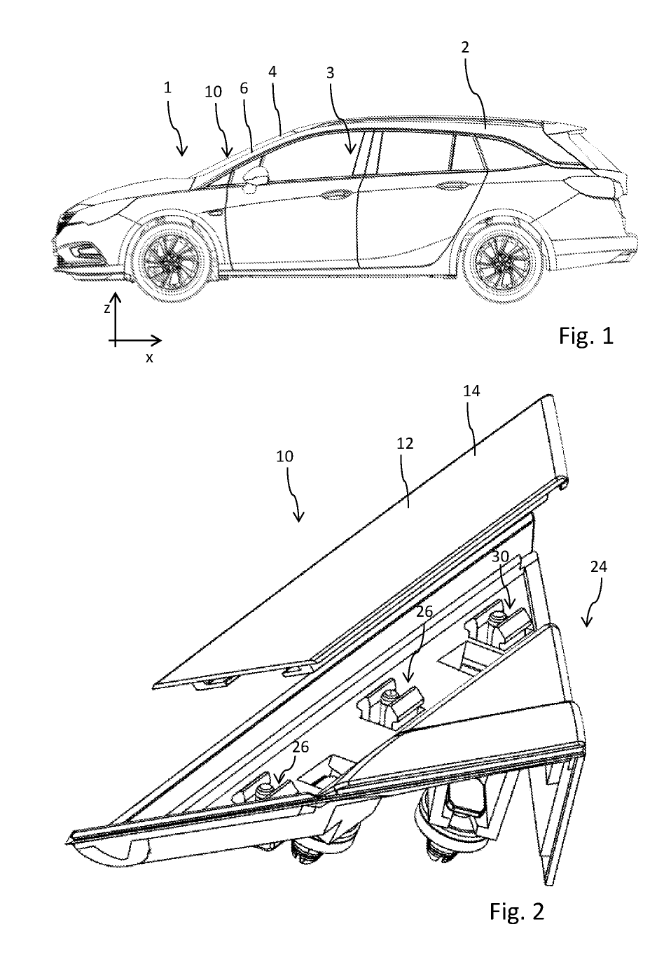

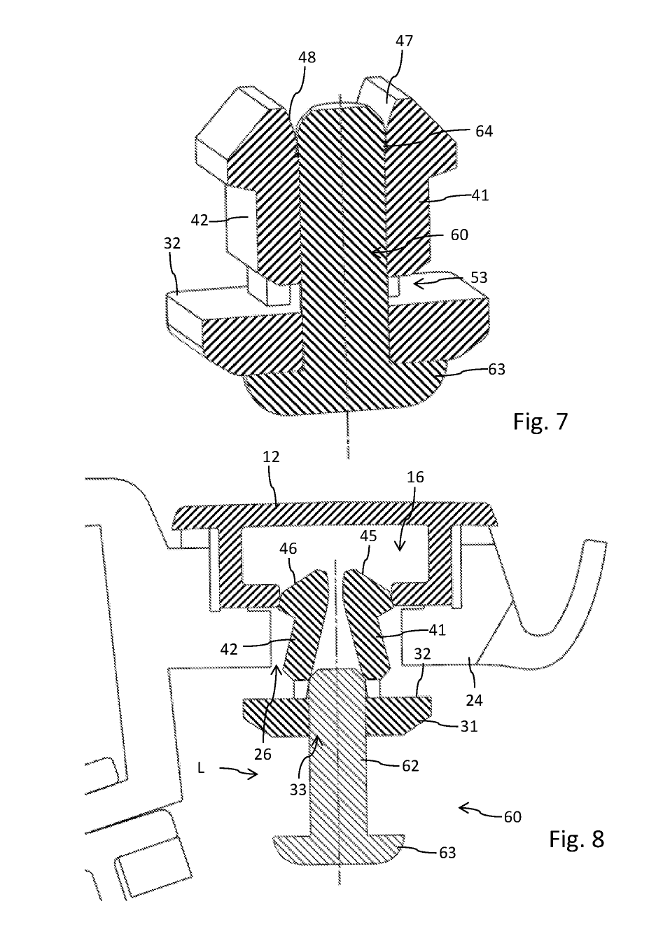

FIGS. 1-11 show an exemplary embodiment of a faceplate arrangement 10 in the form of different views and cross sections. The faceplate arrangement 10 is intended for being mounted on the body 2 of a motor vehicle 1 illustrated in FIG. 1. The motor vehicle 1 and its associated motor vehicle body 2, has an interior 3 that forms a passenger compartment. The passenger compartment is defined by a windshield 4 toward the front in the driving direction of the motor vehicle. The windshield 4 is laterally bordered by an A-pillar 6.

The faceplate arrangement 10 shown is located in the region of the so-called mirror triangle, i.e. in the transition from the fender into the A-pillar of the motor vehicle body 2. The faceplate arrangement 10 is illustrated in its entirety in FIGS. 2, 4 and 9 and includes a faceplate 12 with an outer side 14, which serves as the visible surface, and an inner side 15. A mounting profile 16 is formed on the inner side 15. The mounting profile 16 extends in the longitudinal direction of the strip-like faceplate 12. The cross section according to FIG. 3, in particular, shows that the mounting profile 16 includes two limbs 17 that extend parallel to one another. Flange sections 18, which respectively protrude inward and toward one another, are formed on the free end sections of the limbs that face away from the inner side 15 of the faceplate 12.

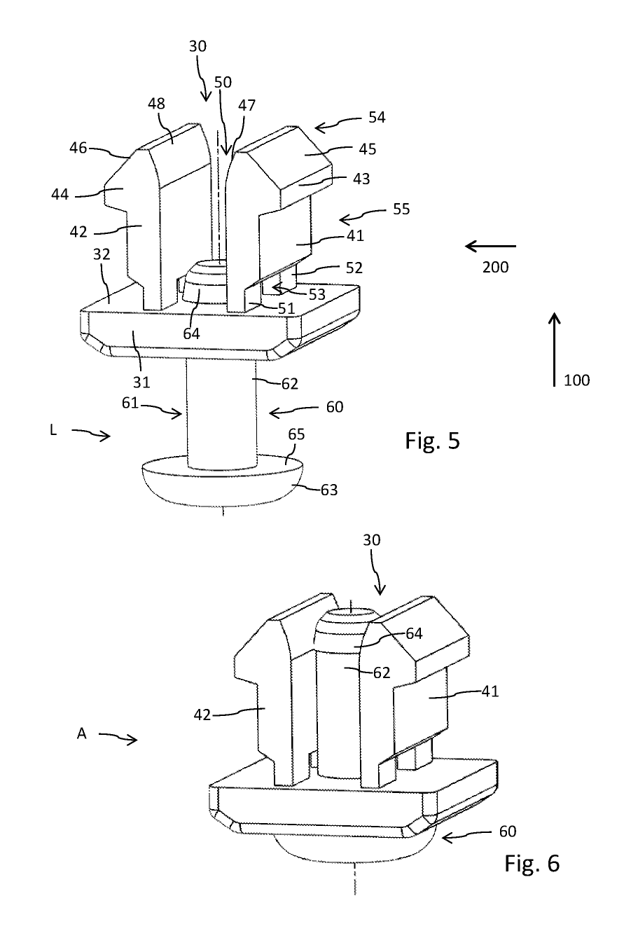

The flange sections 18 and the limbs 17 protruding from the inner side 15 jointly form an undercut that serves for positively connecting the faceplate 12 to a carrier 24. The carrier 24 is typically made of plastic. The faceplate 12 may likewise be made of plastic or a metal, for example of aluminum or special steel. The carrier 24 includes multiple passage openings 26 that are arranged offset to one another in the longitudinal direction of the faceplate 12. The passage openings 26 serves for inserting a mounting clip 30 that is illustrated in two different perspective configurations in FIGS. 5 and 6.

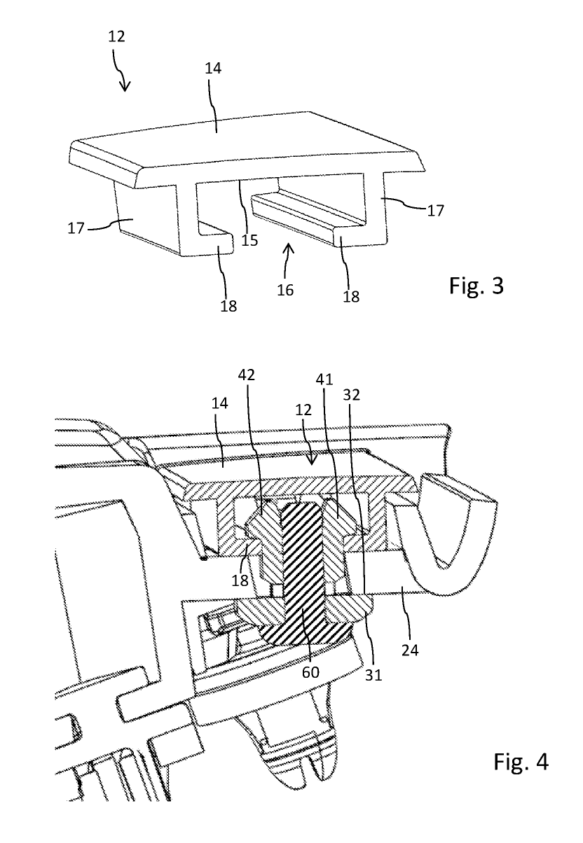

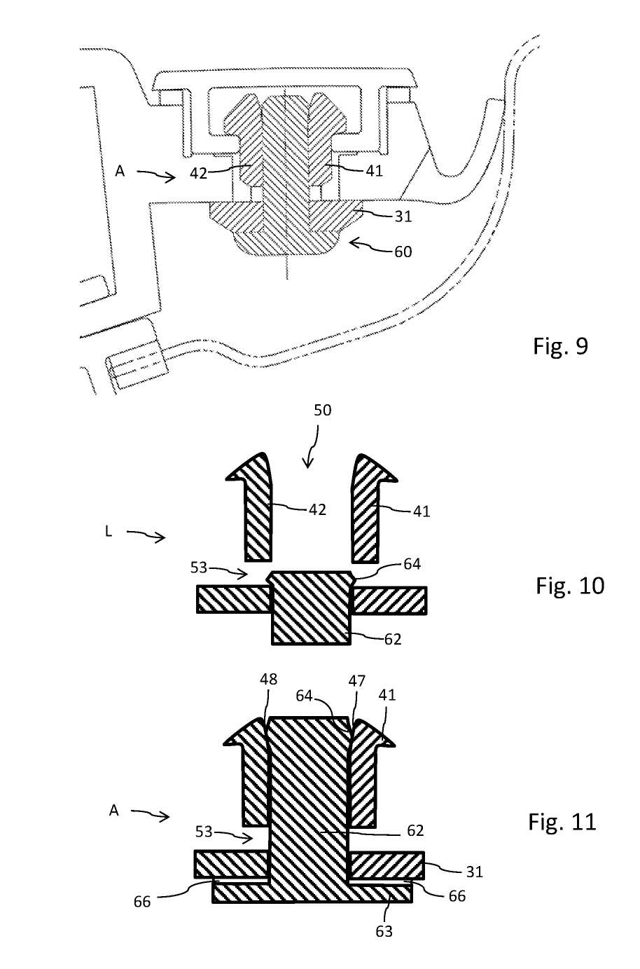

The passage openings 26 may have a rectangular or square geometry. The mounting clip 30 therefore may also have a square or rectangular cross-sectional geometry such that the mounting clip 30 can be non-rotatably arranged in the respective passage opening 26. The mounting clip 30 includes a clip body 31 of plastic. The clip body 31 has an abutment shoulder 32, which in the final installation position illustrated in FIGS. 4 and 9 abuts on an inner side or underside of the carrier 24, particularly along an edge of the passage opening 26.

The mounting clip 30 furthermore includes at least one catch element 41 that extends away from the abutment shoulder 32 along a first direction 100. In the present embodiment, the elongate catch element 41 approximately extends parallel to the surface normal of the abutment shoulder 32. However, the catch element 41 may also extend at a predefined angle to the surface normal of the plane of the abutment shoulder 32.

In the present exemplary embodiment, the mounting clip 30 includes two catch elements 41, 42 that essentially extend parallel to one another in their normal position. The catch elements 41, 42 are arranged on an upper side of the clip body 32 and spaced apart from one another by a predefined distance. The upper side of the clip body 31 simultaneously forms the abutment shoulder 32 or the upper side of the clip body 31 coincides with the abutment shoulder 32.

A locking element 60 can be arranged between the two catch elements 41, 42. In the present exemplary embodiment, a passage opening 33 is located in the clip body 31 between the catch elements 41, 42. The locking element 60 is guided in the passage opening in a longitudinally displaceable fashion. A comparison of FIGS. 5 and 6 shows that the locking element 60 is arranged on the clip body 31 in a release position L. It can furthermore be transferred from the release position L into a locking position A illustrated in FIG. 6. In the locking position A, the locking element 60 almost completely fills the intermediate space 50 between the first catch element 41 and the second catch element 42.

The two catch elements 41, 42 are realized flexibly along a second direction 200 or may be arranged on the clip body 31 such that they are pivotable along the second direction 200. The second direction 200 differs from the first direction 100. For example, the second direction 200 may extend perpendicular to the first direction 100. A longitudinal extent of the catch elements 41, 42 may extend along the first direction 100 and the catch elements may be arranged on the clip body 31 such that they are flexible or pivotable transverse to the first direction 100. The first catch element 41 includes an outwardly protruding catch projection 43 with a run-up slope 45, which is tapered toward the free end, on its free end section 24 that faces away from the clip body 31.

The second catch element 42 also includes a catch projection 44, which protrudes outward from the catch element 42 and is provided with a run-up slope 46, on its outer side that faces away from the first catch element 41. On their inner side, i.e. on their facing inner surfaces, the catch elements 41, 42 respectively include a recess 47, 48 or a bevel on their free end sections 54 such that the clearance between the catch elements 41, 42 increases toward the free end section 54.

In order to positively connect the faceplate 12 to the carrier 24, the faceplate 12 is arranged with its mounting profile 16 on the outer side of the carrier 24 in such a way that the intermediate space formed between the flange sections 18 of the mounting profile 16 is approximately aligned with the passage openings 26 of the carrier 24. A mounting clip 30 is then respectively guided through the passage openings 26 from the inner side of the carrier 24. Due to the run-up slopes 45, 46, the catch elements 41, 42 are pivoted inward and therefore toward one another during the insertion into the mounting profile 16. FIG. 8, in particular, shows that the first catch element 41 moves toward the left along the second direction 200 whereas the second catch element 42 moves toward the right opposite to the second direction 200.

The recesses 47, 48 on the facing inner surfaces of the catch elements 41, 42 on the one hand allow a comparatively large and inwardly directed pivoting motion of the catch elements 41, 42. Due to the recesses 47, 48, the catch elements 41, 42 can be moved closer toward one another before their inner surfaces abut on one another in the region of the free end sections 54.

Due to their elasticity and flexibility, the catch elements 41, 42 with their catch projections 43, 44 engage with the inner side of the flange sections 18 of the mounting profile 16 as soon as a final installation configuration is reached as illustrated in FIG. 4 or 9. After this engagement has been produced, it is proposed to insert the locking element 60 into the intermediate space 50 between the catch elements 41, 42 along the passage opening 33.

For this purpose, the locking element 60 is displaced from its release position L according to FIGS. 5 and 8 into the locking position A according to FIG. 6 or 9. The locking element 60 is presently realized in the form of a locking pin 61. It includes an elongate shaft 62 that is guided in the passage opening 33 of the clip body 31 in a longitudinally displaceable fashion. The locking element 60, i.e. the locking pin 61, has a radially widened head 63 on its underside, i.e. facing the underside of the clip body 31.

Once the locking position A is reached, the head 63 abuts on an underside of the clip body 31 that faces away from the catch elements 41, 42 with an abutment surface 65. The shaft 62 almost completely fills the intermediate space 50 between the catch elements 41, 42 once the locking position A is reached. This prevents the catch elements 41, 42 from respectively moving toward one another along the second direction 200 or opposite to the second direction 200. The positive connection between the catch projections 43, 44 and the mounting profile 16 therefore remains engaged and can only be separated after the locking element 60, i.e. its shaft 62, has been removed from the intermediate space 50.

The shaft 62 includes a shaft widening 64 in the region of its free end that faces away from the head 63 in order to prevent the locking element 60 from detaching from itself. This shaft widening is illustrated in a slightly enlarged fashion in FIGS. 10 and 11. In the locking position A illustrated in FIG. 11, the shaft widening 64 is located in the region of the recesses 47, 48 of the catch elements. In this way, a positive connection between the shaft 62 and the catch elements 41, 42 can be produced. The shaft widening 64 may be in the release position L also located in a recess 53 on the base of at least one of the catch elements 41, 42 as illustrated in FIG. 10. In this way, the locking element 60 can also be captively retained on the mounting clip 30 in the release position L.

In this context, the recesses 47, 48 have a double function. On the one hand, they allow a comparatively large and inwardly directed pivoting motion or elastic deformation of the catch elements 41, 42. On the other hand, the recesses 47, 48 make it possible to axially secure the locking element 60 once it has assumed its locking position A.

The catch elements 41, 42 respectively include two bases 51, 52, by means of which the catch elements 41, 42 are respectively arranged on the abutment shoulder 32 on the clip body 31, as illustrated with reference to the first catch element 41 in FIG. 5. A recess 53 is located between the bases 51, 52 and presently realized in the form of a passage opening. The recess 53 on the one hand serves for accommodating the shaft widening 64 of the locking element 60 when it is in the release position L. On the other hand, the recess 53 makes it possible to pivot or flexibly deform the catch elements 41, 42 in a particularly smooth fashion.

The abutment surface 65 of the radially widened head 63 of the locking element 60, which abuts on the underside of the clip body 31, may include a depression 66 that borders on the outer edge of the head 63 and is realized, for example, in the form of a radially extending slot as indicated in FIG. 11. This depression 66 is illustrated in FIG. 11 only. It may be realized, for example, in the form of a radial groove in the abutment surface 65. Such a depression 66 makes it possible to insert a tool such as a screwdriver, for example, in order to transfer the locking element 60 from the locking position A into the release position L. This allows the removal of the clip 30.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A mounting clip for mounting a faceplate on a motor vehicle body, the mounting clip comprising:
a clip body with an abutment shoulder and a catch element extending away from the abutment shoulder in a first direction and arranged on the clip body such that the catch element is moveable in a second direction which is transverse to the first direction; and
a locking element supported in the clip body for sliding movement in the first direction between a release position such that the locking element permits movement of the catch element in the second direction and a locking positions that blocks movement of the catch element in the second direction.

17. The mounting clip according to claim 16, wherein the catch element comprising a catch body having a first end fixed to the abutment shoulder and a second free end with a an outwardly extending catch projection formed thereon.

18. The mounting clip according to claim 17, wherein the catch projection comprises a run-up slope protruding from an outer side of the catch element facing away from the locking element.

19. The mounting clip according to claim 16, wherein the catch element comprises a first catch body and a second catch body arranged on the clip body at a predefined spacing from the first catch body, wherein the catch element is flexible in the second direction.

20. The mounting clip according to claim 19, wherein the first and second catch body are symmetrically arranged on the clip body relative to a longitudinal axis of the locking element.

21. The mounting clip according to claim 19, wherein the clip body further comprises an intermediate space formed between the first and second catch bodies, wherein the locking element is situated in the intermediate space when in the locked position and is situated outside the intermediate space when in the release position.

22. The mounting clip according to claim 19, wherein the locking element has an outside diameter that essentially corresponds to the predefined spacing between the first and second catch bodies.

23. The mounting clip according to claim 19, wherein the clip body further comprises a through bore formed in between the first and second catch bodies, wherein the locking element is received in the clip body such that the locking element is longitudinally displaceable in the through bore.

24. The mounting clip according to claim 16, wherein the locking element comprises a locking pin with an elongate shaft and an enlarged head formed on a first end of the elongate shaft.

25. The mounting clip according to claim 24, the catch element comprises a recess formed in a base adjacent the abutment shoulder.

26. The mounting clip according to claim 25, wherein the locking element further comprises a shaft widening formed on a second end of the shaft opposite the first end, wherein the shaft widening is configured to positively engage with the recess when the locking element is in the release position.

27. The mounting clip according to claim 25, wherein elongate shaft extends from a face of the enlarged head and the face includes at least one depression bordering on an outer edge of the head.

28. A mounting clip for mounting a faceplate on a motor vehicle body, the mounting clip comprising:
a locking pin including an elongate shaft having a longitudinal axis and an enlarged head formed on a first end of the elongate shaft;
a clip body having a first catch body extending away from an abutment shoulder and having a first fixed end fixed to the clip body and a first free end opposite the first fixed end, a second catch body extending away from the abutment shoulder in a spaced relation to the first catch body and having a second fixed end fixed to the clip body and a second free end opposite the second fixed end, and a through bore formed in the clip body between the first and second catch bodies, wherein the first and second catch bodies are elastically positionable in a radial direction of the through bore;
wherein a second end of the elongate shaft is received in the through bore such that the locking pin is supported for sliding movement in a first direction parallel to the longitudinal axis between a release position such that the first and second catch bodies are flexible in the radial direction and a locking position such that the first and second catch bodies are fixed in the second direction.

29. The mounting clip according to claim 28, wherein each of the first and second free ends have a catch projection with a run-up slope protruding from an outer side thereof facing away from the locking pin.

30. The mounting clip according to claim 28, wherein each of the first and second catch bodies comprises a recess formed in a base adjacent the abutment shoulder.

31. The mounting clip according to claim 30, wherein the locking pin further comprises a shaft widening formed on a second end of the shaft opposite the first end, wherein the shaft widening is configured to positively engage with the recesses formed in the first and second catch bodies when the locking element is in the release position.

32. A faceplate assembly for mounting on a motor vehicle body, the faceplate assembly comprising:
a carrier having at least one passage opening;
a faceplate connected to the carrier and having a mounting profile on an inner side facing the carrier; and
a mounting clip including a clip body with an abutment shoulder and a catch element extending away from the abutment shoulder in a first direction and arranged on the clip body such that the catch element is moveable in a second direction which is transverse to the first direction, a locking element supported in the clip body for sliding movement in the first direction between a release position such that the catch element is positionable in the second direction and a locking position such that the catch element is block along the second direction;
wherein the mounting clip positively engages with the mounting profile of the faceplate with the first catch element in such a way that the first catch element it extends through the passage opening of the carrier.
